(19) United States
(12) Patent Application Publication
(10) Pub. No.: US 2022/0015579 A1
(43) Pub. Date: Jan. 20, 2022

(54) Drainable Bowl Apparatus

(71) Applicant: Adan Escobedo, Oxnard, CA (US)

(72) Inventor: Adan Escobedo, Oxnard, CA (US)

(21) Appl. No.: 16/929,600

(22) Filed: Jul. 15, 2020

(51) Int. Cl. A47J 43/22

(52) U.S. Cl. CPC A47J 43/22

(57) ABSTRACT

A drainable bowl apparatus for separating liquid from solid food while eating includes a bowl body having a bowl bottom, a bowl sidewall, a bowl inner face, and a bowl outer face. The bowl bottom has a plurality of drain apertures extending from the bowl inner face through the bowl outer face. A catch base is coupled to the bowl body. The catch base has a base upper rim, a base sidewall coupled to the base upper rim, and a base bottom coupled to the base sidewall. The base upper rim is selectively engageable with the bowl bottom. The base sidewall is collapsible to move the base bottom between a collapsed position proximal the bowl bottom and an extended position with the base bottom spaced in parallel opposition from the bowl bottom.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bowl devices and more particularly pertains to a new bowl device for separating liquid from solid food while eating.

### (2) Description of Related Art Including Information Disclosed Under 37 CFR 1.97 and 1.98

The prior art relates to bowl devices that allow for drainage and separation of liquid and solid contents. Existing devices offer perforated bases and catch bases for liquid, yet these bases are often fixed and create an abnormal aesthetic for the bowl.

### BRIEF SUMMARY OF THE INVENTION

An embodiment of the disclosure meets the needs presented above by generally comprising a bowl body having a bowl bottom, a bowl sidewall, a bowl inner face, and a bowl outer face. The bowl bottom has a plurality of drain apertures extending from the bowl inner face through the bowl outer face. A catch base is coupled to the bowl body. The catch base has a base upper rim, a base sidewall coupled to the base upper rim, and a base bottom coupled to the base sidewall. The base upper rim is selectively engageable with the bowl bottom. The base sidewall is collapsible to move the base bottom between a collapsed position proximal the bowl bottom and an extended position with the base bottom spaced in parallel opposition from the bowl bottom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a drainable bowl apparatus according to an embodiment of the disclosure.

FIG. 2 is an isometric exploded view of an embodiment of the disclosure.

FIG. 3 is a bottom plan view of an embodiment of the disclosure.

FIG. 4 is a front elevation view of an embodiment of the disclosure.

FIG. 5 is a front elevation view of an embodiment of the disclosure.

FIG. 6 is a cross-sectional view of an embodiment of the disclosure along the line 6-6 of FIG. 4.

### DETAILED DESCRIPTION OF THE INVENTION

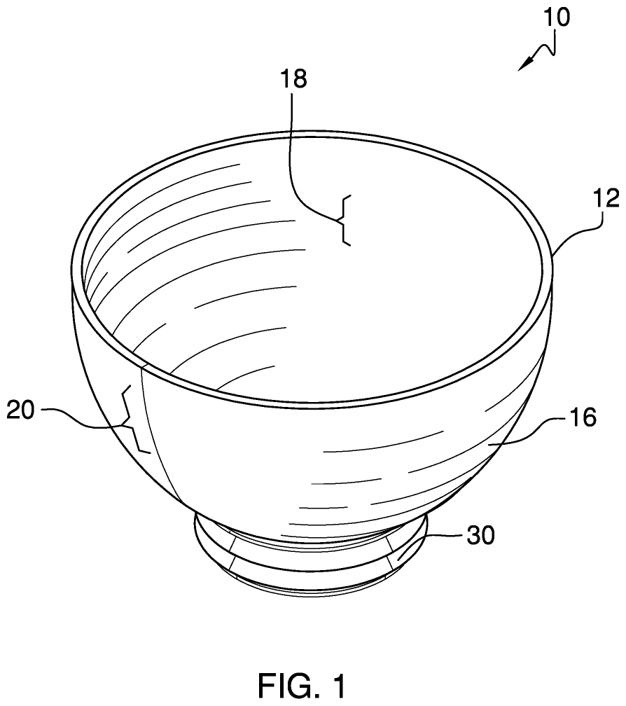

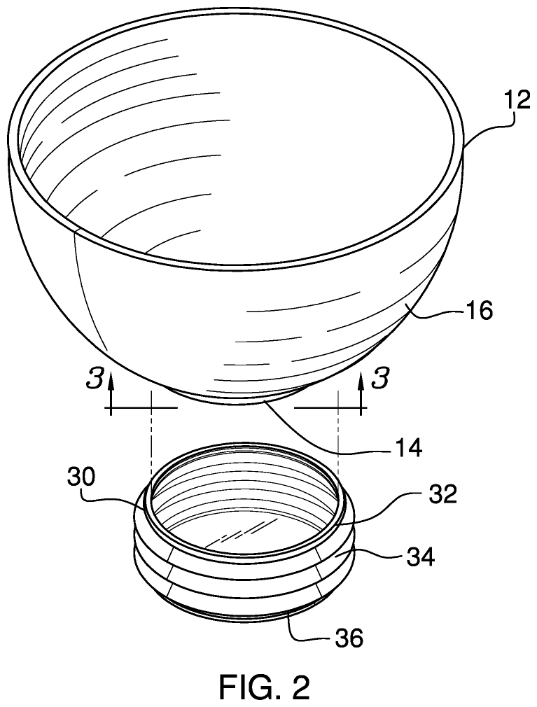

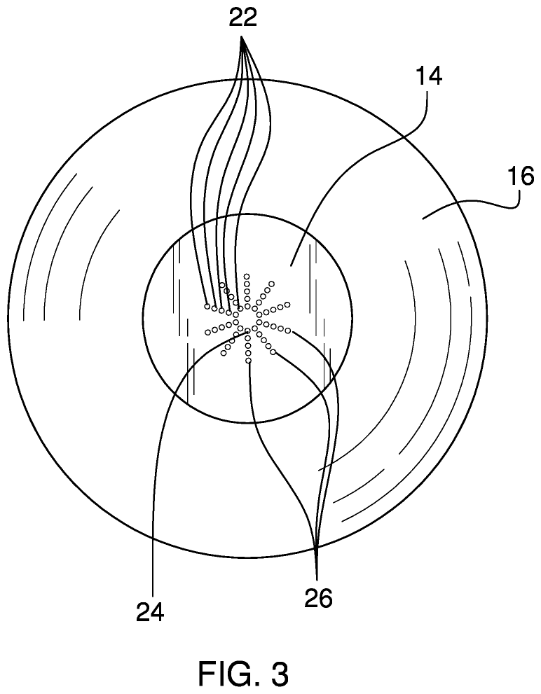

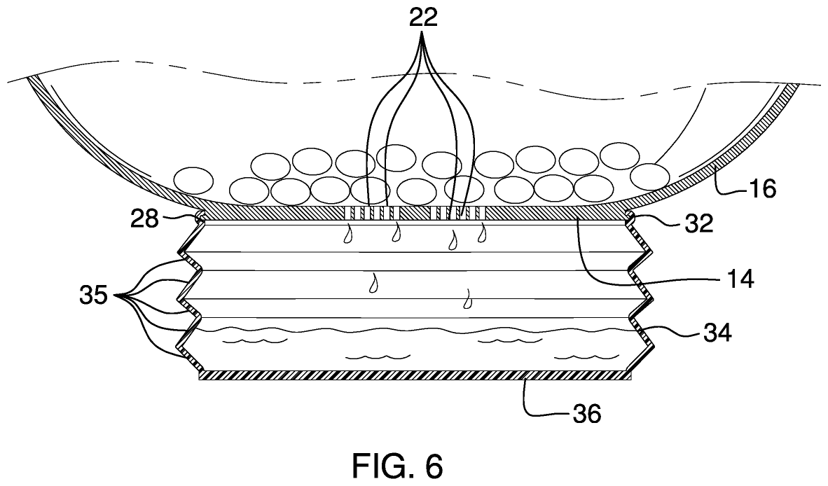

With reference now to the drawings, and in particular to FIGS. 1 through 6 thereof, a new bowl device embodying the principles and concepts of an embodiment of the disclosure and generally designated by the reference numeral 10 will be described.

As best illustrated in FIGS. 1 through 6, the drainable bowl apparatus 10 generally comprises a bowl body 12 having a bowl bottom 14, a bowl sidewall 16, a bowl inner face 18, and a bowl outer face 20. The bowl sidewall 16 may have a curved profile and height conforming to a variety of standard bowl dishes.

The bowl bottom 14 may be circular and protrudes from the bowl outer face 20. The bowl bottom 14 has a plurality of drain apertures 22 extending from the bowl inner face 18 through the bowl outer face 20. The plurality of drain apertures 22 may include a central ring 24 of drain apertures and a plurality of linear arrays 26 of drain apertures radiating from the central ring 24 of drain apertures. The bowl bottom 14 may have an outer lip 28.

A catch base 30 is coupled to the bowl body 12. The catch base 30 has a base upper rim 32, a base sidewall 34 coupled to the base upper rim 32, and a base bottom 36 coupled to the base sidewall 34. The base upper rim 32 is selectively engageable with the bowl bottom 14. The base upper rim 32 may be snappingly engageable between the outer lip 28 and the bowl outer face 20. The base upper rim 32 may alternatively be threadably engageable with the base bottom 36.

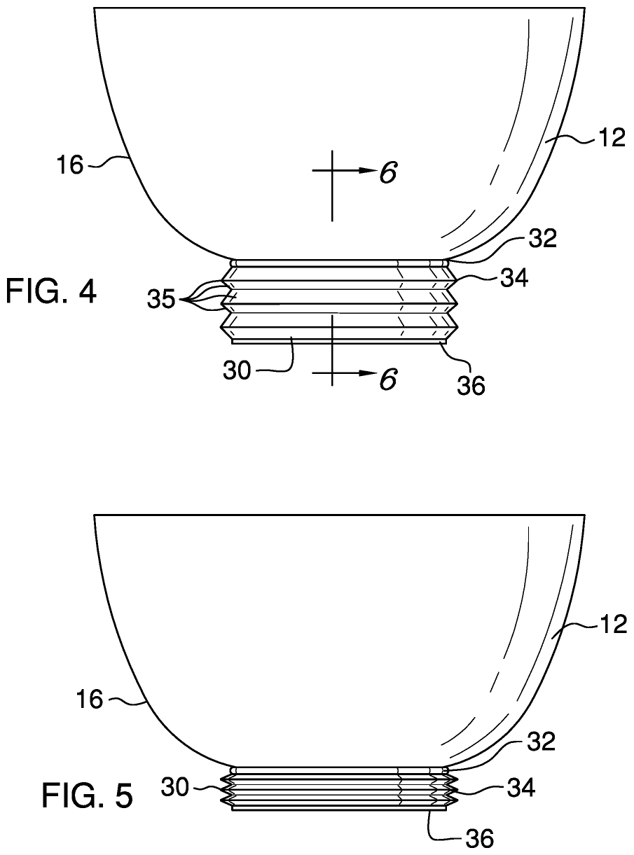

The base sidewall 34 is collapsible to move the base bottom 36 between a collapsed position proximal the bowl bottom 14, as seen in FIG. 5, and an extended position with the base bottom 36 spaced in parallel opposition from the bowl bottom 14, as seen in FIG. 4. The base sidewall 34 may have a plurality of horizontal sidewall sections 35 to expand and contract in an accordion-like fashion along a central axis of the base sidewall 34 between the collapsed position and the extended position. The base sidewall 34 may alternatively be telescopable. The base sidewall 34 is sufficiently rigid to maintain the extended position when the bowl body 12 is filled with food.

In use, the user may at any time extend the base bottom 36 from the collapsed position to the extended position to allow liquid to drain through the plurality of drain apertures 22 into the catch base 30, thus preventing remaining solid food in the bowl body 12 from becoming soggy or difficult to access. If desired, the base bottom 36 may be returned to the collapsed position to allow the liquid to re-enter the bowl body 12. When finished, the catch base 30 may be disengaged from the bowl bottom 14 to empty the liquid and for cleaning.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drainable bowl apparatus comprising:
a bowl body having a bowl bottom, a bowl sidewall, a bowl inner face, and a bowl outer face, the bowl bottom having a plurality of drain apertures extending from the bowl inner face through the bowl outer face; and
a catch base coupled to the bowl body, the catch base having a base upper rim, a base sidewall coupled to the base upper rim, and a base bottom coupled to the base sidewall, the base upper rim being selectively engageable with the bowl bottom, the base sidewall being collapsible to move the base bottom between a collapsed position proximal the bowl bottom and an extended position with the base bottom spaced in parallel opposition from the bowl bottom.

2. The drainable bowl apparatus of claim 1 further comprising the bowl bottom being circular and protruding from the bowl outer face.

3. The drainable bowl apparatus of claim 2 further comprising the bowl bottom having an outer lip, the base upper rim being snappingly engageable between the outer lip and the bowl outer face.

4. The drainable bowl apparatus of claim 2 further comprising the base upper rim being threadably engageable with the bowl bottom.

5. The drainable bowl apparatus of claim 1 further comprising the base sidewall expanding in an accordion-like fashion along a central axis of the base sidewall between the collapsed position and the extended position.

6. The drainable bowl apparatus of claim 1 further comprising the base sidewall expanding in a telescoping fashion along a central axis of the base sidewall between the collapsed position and the extended position.

7. The drainable bowl apparatus of claim 1 further comprising the plurality of drain apertures including a central ring of drain apertures and a plurality of linear arrays of drain apertures radiating from the central ring of drain apertures.

8. A drainable bowl apparatus comprising:
a bowl body having a bowl bottom, a bowl sidewall, a bowl inner face, and a bowl outer face, the bowl bottom being circular and protruding from the bowl outer face, the bowl bottom having a plurality of drain apertures extending from the bowl inner face through the bowl outer face, the plurality of drain apertures including a central ring of drain apertures and a plurality of linear arrays of drain apertures radiating from the central ring of drain apertures, the bowl bottom having an outer lip; and
a catch base coupled to the bowl body, the catch base having a base upper rim, a base sidewall coupled to the base upper rim, and a base bottom coupled to the base sidewall, the base upper rim being selectively engageable with the bowl bottom, the base upper rim being snappingly engageable between the outer lip and the bowl outer face, the base sidewall being collapsible to move the base bottom between a collapsed position proximal the bowl bottom and an extended position with the base bottom spaced in parallel opposition from the bowl bottom, the base sidewall expanding in an accordion-like fashion along a central axis of the base sidewall between the collapsed position and the extended position.
